(19) United States
(12) Patent Application Publication
(10) Pub. No.: US 2017/0206815 A1
(43) Pub. Date: Jul. 20, 2017

(54) Decorative Infinity Display

(71) Applicant: Jimmy Whitmire, Graford, TX (US)

(72) Inventor: Jimmy Whitmire, Graford, TX (US)

(21) Appl. No.: 15/000,313

(22) Filed: Jan. 19, 2016

(51) Int. Cl. G09F 19/16; F21V 23/06; F21V 23/00; F21V 23/04; F21V 7/00; F21V 7/05

(52) U.S. Cl. CPC G09F 19/16; F21V 7/0033; F21V 7/05; F21V 23/001; F21V 23/04; F21V 23/06; F21W 2121/00

(57) ABSTRACT

A decorative infinity display which comprises a front frame having an opening. A two-way mirror is mounted to a rear surface of the front frame to cover the opening. A housing is affixed to the rear surface of the front frame about the two-way mirror. An illuminable assembly has a plurality of spaced apart inwardly facing peripheral lights. The illuminable assembly is placed within the housing. A back panel is provided. A reflective mirror is attached to a front surface of the back panel. The back panel is affixed to a rear portion of the housing. When the lights are illuminated an image is formed to create the illusion of depth when viewed through the two way mirror.

### BACKGROUND OF THE INVENTION

Field of the Invention

The present invention relates generally to displays and, more specifically, to a decorative infinity display comprising a housing forming an actuatable artistic display having a switch for generating a reducing infinity-like image of a plurality of peripherally positioned illuminable bulbs.

Description of the Prior Art

There are other displays which provide for displaying a reducing image. While these displays may be suitable for the purposes for which they where designed, they would not be as suitable for the purposes of the present invention as heretofore described.

It is thus desirable to provide a decorative infinity display having a user selectable first state depicting a first image and a user selectable second state depicting a series of receding spaced light images.

It is further desirable to provide a decorative infinity display wherein the first image is not visible while the second image is actuated.

### SUMMARY OF THE PRESENT INVENTION

A primary object of the present invention is to provide a decorative infinity display having a pair of user selectable image displays.

Another object of the present invention is to provide a decorative infinity display having a housing comprising front frame, back wall and side walls therebetween forming a chamber housing a user illuminable display.

Yet another object of the present invention is to provide a decorative infinity display in which a front wall having a peripheral frame encompasses a two way mirror.

Still yet another object of the present invention is to provide a decorative infinity display in which the peripheral frame material is selected from the group consisting of metal, wood, polymeric material and elastomeric material.

An additional object of the present invention is to provide a decorative infinity display in which the two way mirror is for viewing the display when illuminated.

A further object of the present invention is to provide a decorative infinity display in which the two way mirror will have an image incorporated into and/or onto the mirror.

A yet further object of the present invention is to provide a decorative infinity display in which a support structure is for a plurality of illuminable bulbs.

A still yet further object of the present invention is to provide a decorative infinity display in which the support structure comprises a planar surface having a corresponding plurality of receptacles for a corresponding plurality of illuminable bulbs.

Another object of the present invention is to provide a decorative infinity display in which the support structure planar surface is formed in an ovoid or polygonal structure.

Yet another object of the present invention is to provide a decorative infinity display in which the support planar surface(s) are supplied with exterior supports for positioning a bulb support surface within the peripheral frame.

Still yet another object of the present invention is to provide a decorative infinity display in which the illuminable bulbs are selected from incandescent bulbs and light emitting diodes (LED).

An additional object of the present invention is to provide a decorative infinity display in which the illuminable bulbs have variable states of color.

A further object of the present invention is to provide a decorative infinity display in which the color states are definitive states, such as red, blue white, green, etc. and a variable state, such as progressively moving from one visible wavelength to another visible wave length over a predetermined time period.

A yet further object of the present invention is to provide a decorative infinity display in which the illuminable display with a power source is selected from the group consisting of electrical grid, internal battery, and renewable energy, such as solar powered and wind powered.

Additional objects of the present invention will appear as the description proceeds.

The present invention overcomes the shortcomings of the prior art by providing a decorative infinity display comprising a housing forming an actuatable artistic display having a switch for generating a reducing infinity-like image of a plurality of peripherally positioned aluminum bulbs. A user selectable first state is for depicting a first image and a user selectable second state is for depicting a series of receding spaced light images. The first image is not visible while the second image is actuated.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention in use.

FIG. 2 is a partial exploded perspective view of a front portion of the present invention.

FIG. 3 is a perspective view of a middle portion of the present invention.

FIG. 4 is a perspective view of a back portion of the present invention.

FIG. 5 is a partial exploded perspective view of the present invention.

FIG. 6 is a partial exploded perspective view of the present invention.

FIG. 7 is an assembled perspective view of the present invention.

FIG. 8 is an assembled front view of the present invention taken in the direction of arrow 8 in FIG. 7.

FIG. 9 is an exploded perspective view of all the elements of the present invention.

FIG. 10 is a partial exploded perspective view of the present invention.

FIG. 11 is an assembled perspective view of the present invention similar to FIG. 7.

### DESCRIPTION OF THE REFERENCED NUMERALS

Turning now descriptively to the drawings, in which similar reference characters denotes similar elements throughout the several views, the Figures illustrate the decorative infinity display of the present invention. With regard to the reference numerals used, the following numbering is used throughout the various drawing figures.
20 decorative infinity display
22 front frame of display 20
23 housing of display 20
24 two way mirror of display 20
26 illuminable assembly of display 20
28 light of assembly 26
30 electrical cord of assembly 26
32 on/off switch on electrical cord 30
34 wall plug on electrical cord 30
36 back panel of display 20
38 mirror on back panel 36
39 image on mirror 24
40 wall of housing 23
42 chamber in housing 23
43 opening in frame 22
44 support structure of assembly 26
46 receptacle in support structure 44
48 flange of assembly 26
50 exterior channel in support structure 44

### DETAILED DESCRIPTION OF THE PREFERRED EMBODIMENT

The following discussion describes in detail an embodiment of the invention. This discussion should not be construed, however, as limiting the invention to this particular embodiment, practitioners skilled in the art will recognize other embodiments as well. For definition of complete scope of the invention, the reader is directed to appended claims.

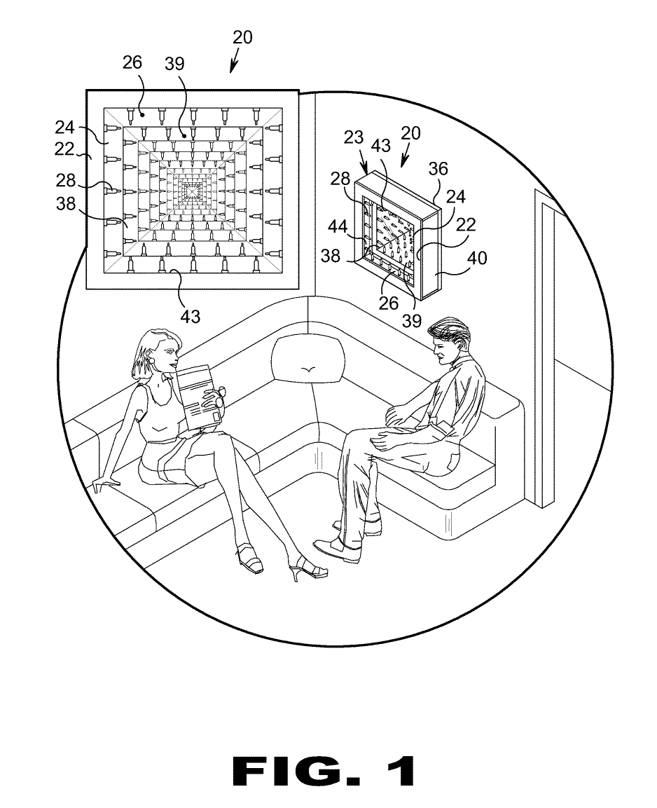

Referring to FIG. 1, shown is an illustrative view of the present invention in use. The present invention is a decorative infinity display comprising of front frame 22, housing 23, a two way mirror 24, an illuminable assembly 26 having a plurality of lights 28, an on/off switch 32 and a wall plug 34. A back panel 36 having a mirror 38 that reflects the lights 28 giving an image 39 of infinity is also provided.

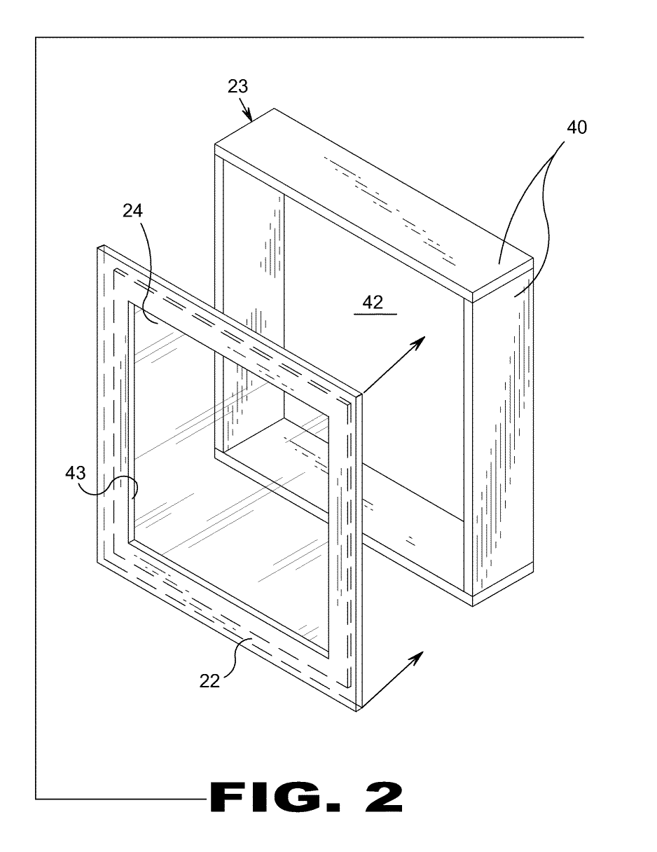

Referring to FIG. 2, shown is an illustrative view of the present invention in use. Shown is a peripheral front frame having a two way mirror fixedly attached thereto with wall(s) forming chamber for the illuminable display. The frame, wall(s) and back wall are illustrated as polygonal but it is envisioned that they may also be ovoid.

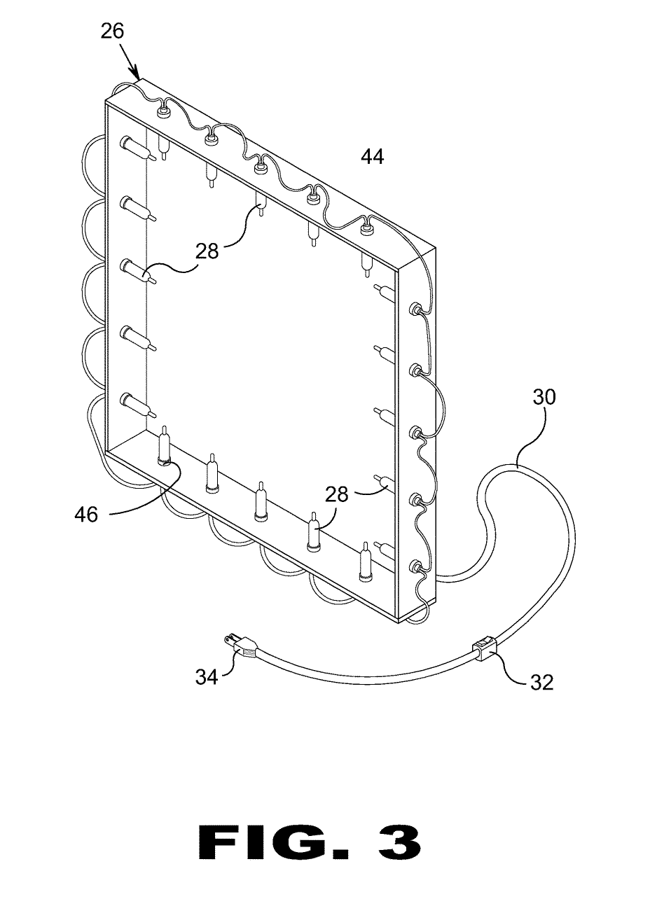

Referring to FIG. 3, shown is a perspective view of the middle portion of the present invention. Shown is the illuminable assembly 26 comprising support structure 44 having receptacles 46 to receive a corresponding number of lights 28, which may be incandescent bulbs or light emitting diodes (LEDs). Furthermore, the power source may be an electrical grid or provided by renewal energy, such as wind and solar.

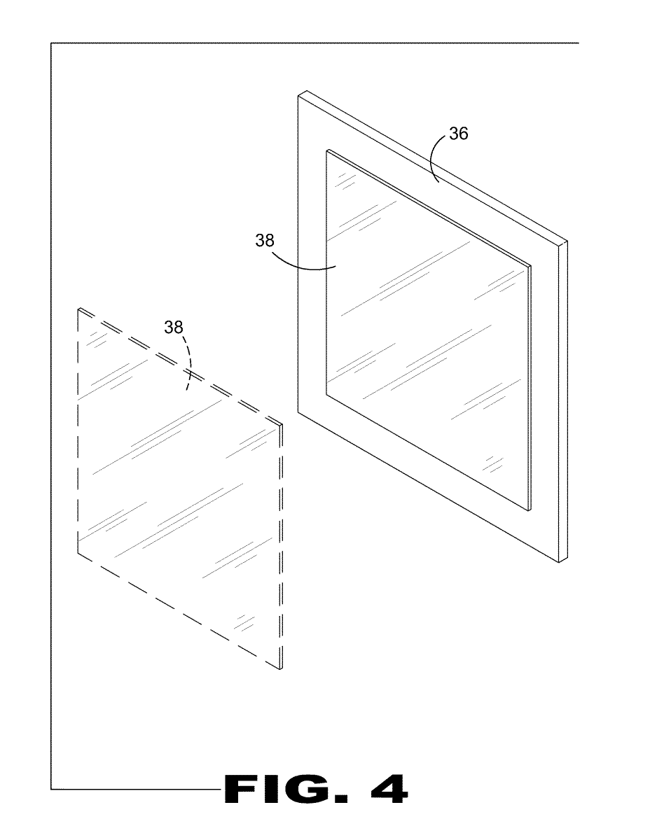

Referring to FIG. 4, shown is a perspective view of a back portion of the present invention. Shown is the back panel 36 of the decorative infinity display 20 having the mirror 38 fixedly attached thereto.

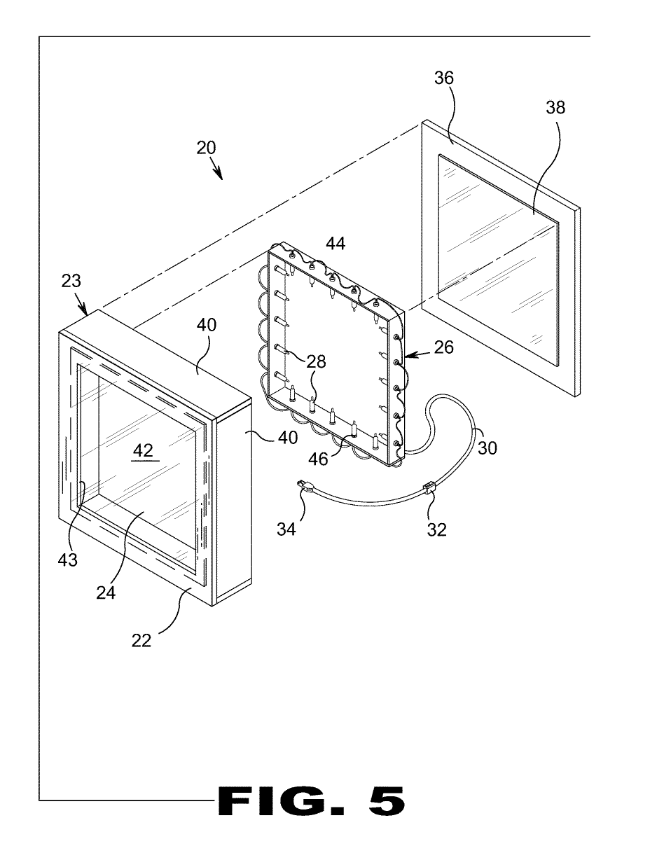

Referring to FIG. 5, shown is a partial exploded perspective view of the present invention. Shown is an exploded view of the decorative infinity display 20 having the frame 22 with the two way mirror 24 covering an opening 43 of the frame 22 that is fixedly attached to the walls 40 of the housing 23 in which mates to the back panel 36 having the mirror 38 thereon, thereby creating the chamber 42 to receive the illuminable assembly 26 therein.

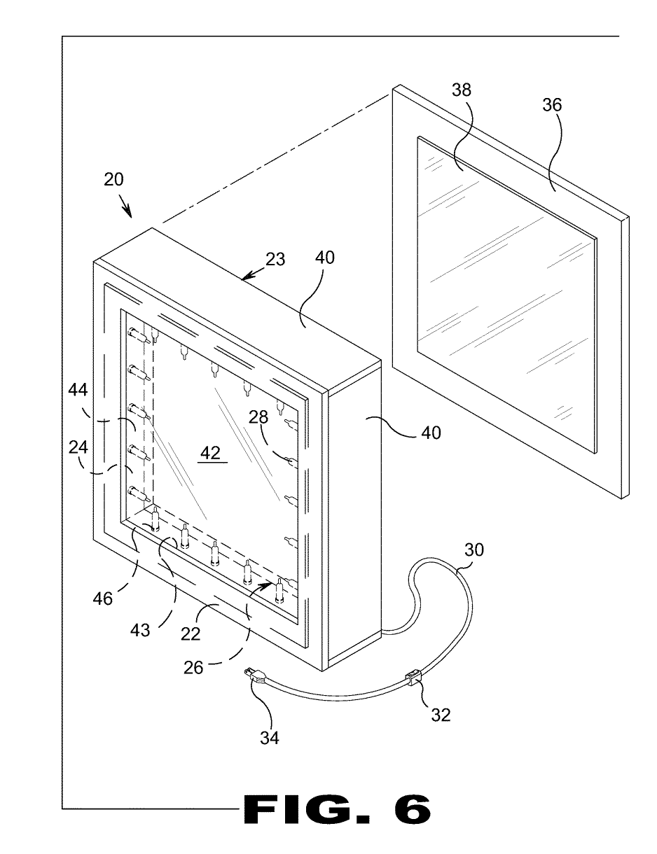

Referring to FIG. 6, shown is a partial exploded perspective view of the present invention. Shown is a partial exploded view of the decorative infinity display 20 having the frame 22, housing 23, and aluminum assembly 26 affixed to back panel 36 and mirror 38 not assembled.

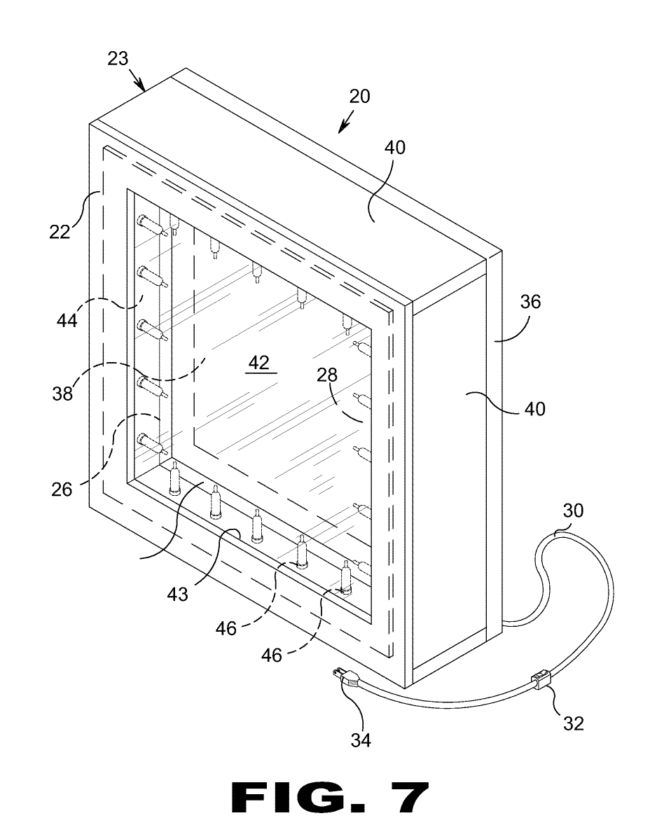

Referring to FIG. 7, shown is an assembled perspective view of the present invention. Shown is the decorative infinity display fully assembled and having the frame 22, two way mirror 24, the housing 23, the illuminable assembly 26, the electrical cord 30 having the on/off switch 32 with wall plug 34, and back panel 36 having a mirror 38 that reflects the lights 28 giving the image 39 of infinity.

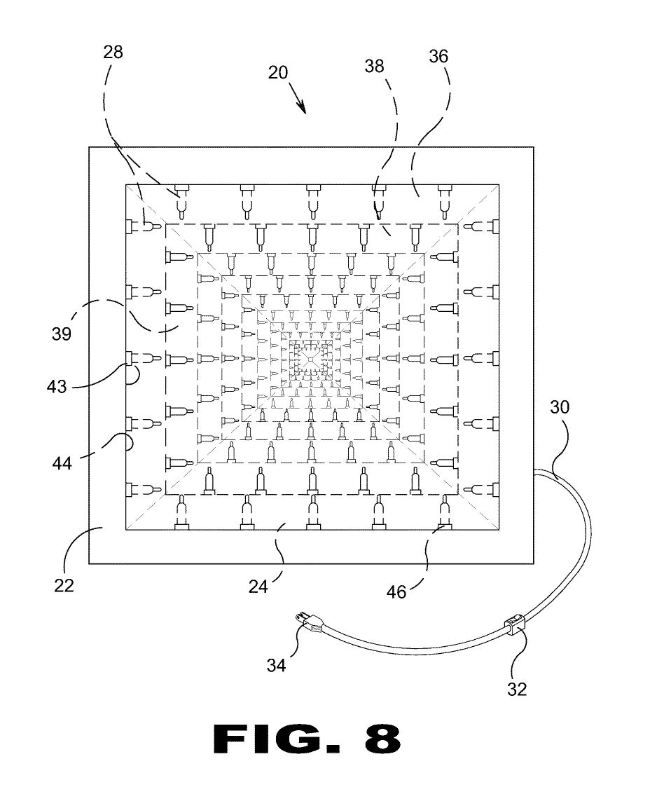

Referring to FIG. 8, shown is an assembled front view of the present invention taken in the direction of arrow 8 in FIG. 7. Shown is the decorative infinity display 20 fully assembled and in operation having the two way mirror 24 covering the opening 43 of the frame 22, so that when illuminated the points of light between the two mirrors 24, 28 will generate a reducing infinity image 39.

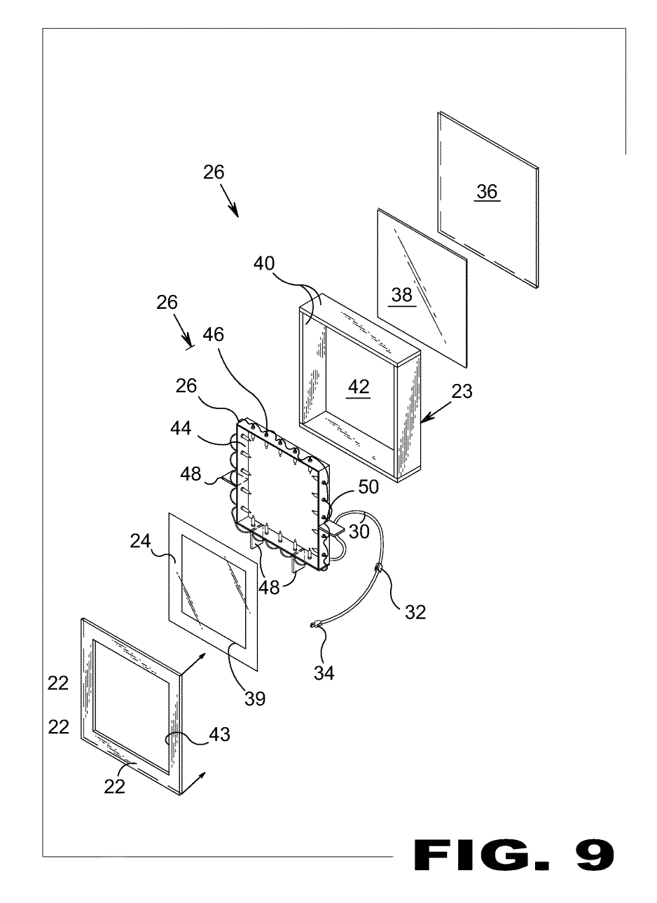

Referring to FIG. 9, shown is an exploded perspective view of all the elements of the present invention. Shown is an exploded view of the decorative infinity display 20 having flanges 48 peripherally extending from the illuminable assembly 26 that will hold the illuminable assembly 26 to the walls 40 of the housing 23 preventing casual displacement during use. The illuminable assembly 26 may also have exterior channels 50 to receive the positioning flanges 48.

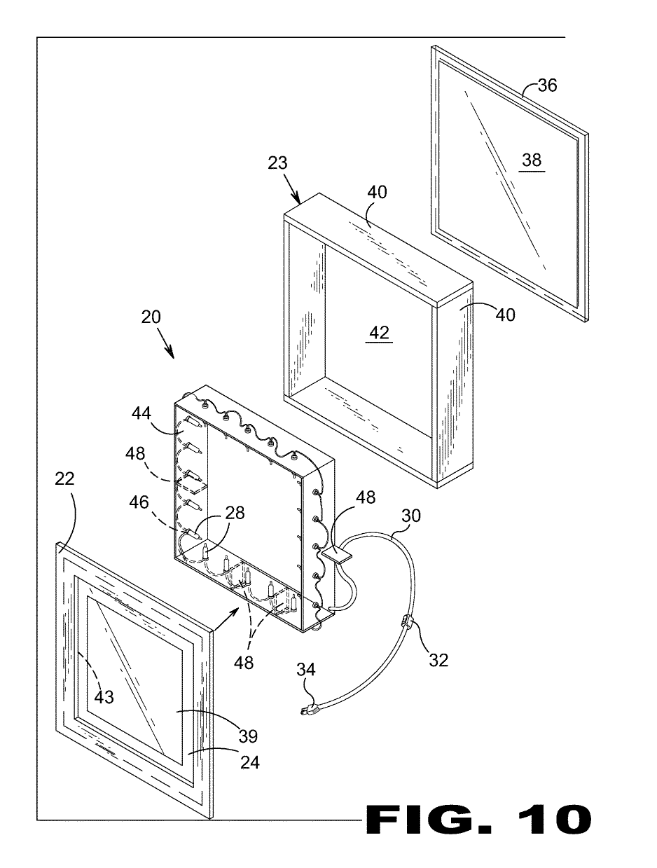

Referring to FIG. 10, shown is a partial exploded perspective view of the present invention. Shown is the decorative infinity display 20 having the frame 22 with the fixedly attached two way mirror 24. The back panel 36 having the reflective mirror 38 is fixedly attached with the walls 40 extending between the front frame 22 and the back panel 36 forming the chamber 42 to receive the illuminable assembly 26 having the plurality of lights 28. The beams reflecting between the two way mirror 24 and the mirror 38 on the back panel 36 will generate the infinitely reducing image 39 when the power is turned on. Further provided the image 39 is viewable on the exterior side of the two way mirror 24. When the display is not illuminated the image 39 will not be visible.

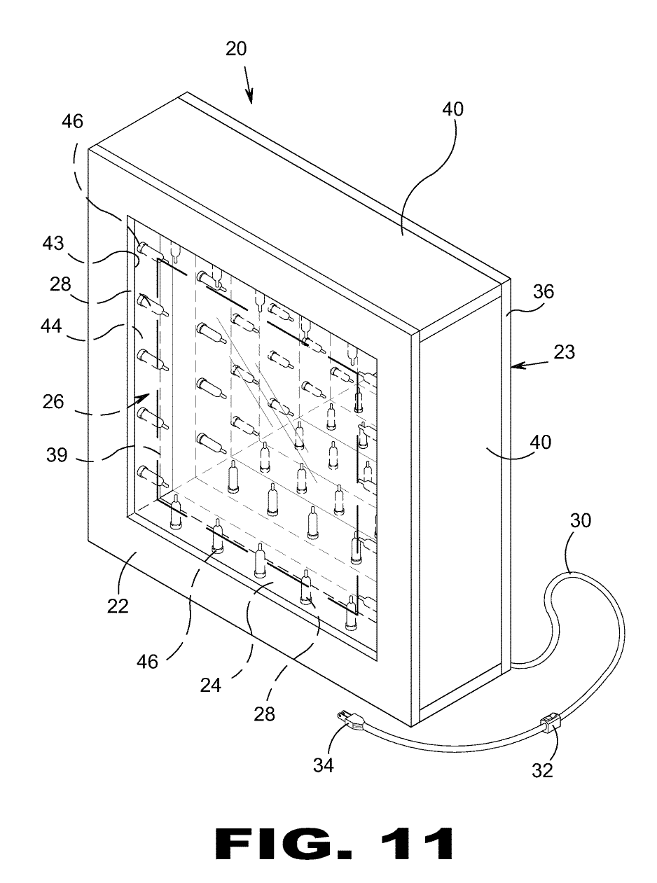

Referring to FIG. 11, shown is an assembled perspective view of the present invention similar to FIG. 7. Shown is the decorative infinity display 20 fully assembled and in operation having the frame 22, the plurality of lights 28, the electrical cord 30, the on/off switch 32 with the wall plug 34. The back panel 36 has the mirror 38 that reflects the lights 28 giving the image 39 of infinity.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

What is claimed is:

1. A decorative infinity display which comprises:
a) a front frame having an opening;
b) a two-way mirror mounted to a rear surface of the front frame to cover the opening;
c) a housing affixed to the rear surface of the front frame about the two-way mirror;
d) an illuminable assembly having a plurality of spaced apart inwardly facing peripheral lights, the illuminable assembly placed within the housing;
e) a back panel; and
f) a reflective mirror attached to a front surface of the back panel, with the back panel affixed to a rear portion of the housing, whereby when the lights are illuminated an image is formed to create the illusion of depth when viewed through the two way mirror.

2. The decorative infinity display as recited in claim 1, wherein the housing comprises four walls forming a chamber in which the illuminable assembly fits therein.

3. The decorative infinity display as recited in claim 1, wherein the illuminable assembly comprises:
a) a box-shaped support structure having four panels thereabout; and
b) a plurality of receptacles spaced apart mounted in the panels of the boxed-shaped support structure, wherein each receptacle holds one of the lights therein.

4. The decorative infinity display as recited in claim 3, wherein the illuminable assembly further comprises:
a) wiring extending between each receptacle; and
b) an electrical cord connected to the wiring.

5. The decorative infinity display as recited in claim 4, wherein the electrical cord comprises:
a) an on/off switch built into the electrical cord; and
b) a wall plug on a distal end of the electrical cord.

6. The decorative infinity display as recited in claim 3, wherein the box-shaped support structure comprises a plurality of flanges peripherally extending outwardly from the panels of the box-shaped support structure that will hold the boxed-shaped support structure within the walls of the housing to prevent casual displacement during use.

7. The decorative infinity display as recited in claim 6, wherein the box-shaped support structure comprises each panel further having an exterior transverse channel to receive one of the flanges therein.
